(19) United States
(12) Patent Application Publication
(10) Pub. No.: US 2024/0022606 A1
(43) Pub. Date: Jan. 18, 2024

(54) AN IMPROVED COMPUTER IMPLEMENTED SYSTEM AND METHOD FOR CYBERSECURITY MANAGEMENT PLATFORM OF A MONITORED NETWORK

(71) Applicant: NEXAGATE SDN BHD, KUALA LUMPUR (MY)

(72) Inventors: Khairil Effendy BIN DATO' AHMAD DHMAN HURI, KUALA LUMPUR (MY); Ahmad Tarmizi BIN AHMAD SHANUSI, KUALA LUMPUR (MY)

(73) Assignee: NEXAGATE SDN BHD, KUALA LUMPUR (MY)

(21) Appl. No.: 18/034,402

(22) PCT Filed: Oct. 31, 2021
(86) PCT No.: PCT/MY2021/050092

§ 371 Date: Apr. 28, 2023

(30) Foreign Application Priority Data
Oct. 28, 2020 (MY) PI2020005639

(51) Int. Cl. H04L 9/40

(52) U.S. Cl. CPC H04L 63/20; H04L 63/1433

(57) ABSTRACT

A computer implemented system (100) and method for a monitored network cybersecurity management platform comprising a processors (102) coupled to a database (104), whereby configured to store an information of a network security policies engine (106) associated with a vulnerability data (108), one or more displays (110) coupled to the processor configured to display an interface of the network security policies engine (106) that provides an executive dashboard for user access; and an integrated unified security management, USM module (112) within the monitored network wherein the USM module (112) wherein, the USM module (112) dynamically generating a risk assessment metrics (124) of the vulnerability data (108), whether the monitored network is complying with the network security policies engines (106). The module automize a stage of the risk assessment metrics (124) via one or more machine learning methods to generate a risk score rating (126) in accordance with the internal and external vulnerability data.

### TECHNICAL FIELD

The present invention relates to a cloud-based computer implemented system and method for a cybersecurity management platform for a monitored network.

### BACKGROUND ART

Assurance that sensitive data is not leaked to unauthorized persons is, therefore, a challenge that organizations need to address in order to protect their business assets and reputation and meet regulatory requirements. To make things more complicated, most information security products are designed to protect networks and servers but do little to protect the confidentiality and integrity of the information itself An information security requires constant monitoring, fine-tuning, updating and maintenance of assets in not only in physical equipment but also in cloud infrastructure of an organization.

The assets for most companies or organization live with always on connections to the Internet, which expose the assets to the inherent risk of viruses, hackers, and denial of service attacks. All of this attack in particular is on the rise and are proving incredibly destructive to organizations business productivity around the globe. In some instances, one or more assets of a network can be vulnerable or open to attack by various cyber threats, such as virus, malware, and hackers. Many business enterprises have internal policies and controls independent of government regulation. These controls and policies may be concerned with security, confidentiality maintenance, trade secret protection, access control, best practices, accounting standards, business process policies, and other such internal rules and controls.

Conventional approaches to evaluating and providing security platform of network can often times be insufficient, ineffective, or otherwise lacking. Moreover, in many cases, conventional approaches can create challenges for and worsen the overall organizations of the network.

U.S. Pat. No. 7,747,494 B1 describes a computer implemented method of assessing risk associated with one or more assets for a business enterprise by comparing a non-determinative real risk score with a non-determinative simulated risk score. However, conventional approaches are generally lacking in providing evaluation and protection measures of this information.

Thus, maintaining the information security is now very crucial and concern fundamental to doing business in the era of Industry 4.0 especially when the network is in a large scale and involving big data to manage. Management controls, operational policies, and accepted information security risks are established mandating specific requirements for implementing, maintaining, monitoring, reviewing/auditing, responding to non-compliance, and improving the organization's ISMS.

An object of the present invention is to provide an improved computer implemented system and method for a monitored network security management all in one platform, unified and accurately compared to the above described prior arts.

### SUMMARY OF INVENTION

The present invention provides a cloud-based computer implemented system (100) for a monitored network security management platform comprising one or more processors (102) coupled to a dynamically-generated electronic database (104), the database configured to store an information of a network security policies engine (106) associated with a vulnerability data (108), one or more displays (110) coupled to the processor configured to display an interface of the network security policies engine (106) that provides an executive dashboard for user access and an integrated unified security management, USM module (112) within the monitored network. The USM module (112) includes integration of a compliance management module (114) for monitoring and analyzing the vulnerability data (108) and identifying an optimum changing reference information of the data (108) that corresponds to a network security policies engine (106 wherein the compliance management module (114) will generate an SOP documentation versions that may be updated through auto versioning capability based on a major or minor revision of the changes modification data; a threat management module (116) for scanning a plurality of an asset (118) of the monitored network that associate with the vulnerability data (108) including the data from an asset of at least one end point device and a data from a connection traffic of security information management (“SIM”) products, enterprise risk management (“ERM”) or the like, through at least an agent (113) wherein the agent (113) is a standalone appliance connected to the monitored network; a security protection module (120) for dynamically accessing the at least information of the vulnerability data (108) for monitoring cyberattack and thereafter updating an antivirus of the asset and web application and an academy portal module (122) for interacting with information security policy knowledge including a phishing simulator to be transmitted through a plurality of messaging channels in the monitored network.

The integrated USM module indicating dynamically generating a risk assessment metrics (124) of the vulnerability data (108), whether the monitored network is complying with the network security policies engines (106), calculate the risk assessment metrics (124) of at least an asset (118) of the network based on the vulnerability data (108) and whether the network is complying with the network security policies engines (106). The USM module further automized a stage of the risk assessment metrics (124) via one or more machine learning methods to generate a risk score rating (126) of the monitored network wherein the score rating (126) is generated from the vulnerability data (108) with predetermined parameters; and receive an indication of the risk assessment metrics (124) of an initial change of at least an asset of the monitored network with customizing at least an internal and external vulnerability data.

In an embodiment, the vulnerability data (108) further comprising a first vulnerability data set from a user requirement (questionnaire) of distributed sources and a second vulnerability data set from the processor (102) in the monitored network. The vulnerability data (108) further integrated with the risk assessment metrics (124) for centrally processing the vulnerability data (108) in order to threat priority associated therewith, the processing comprising, for each vulnerability data (108), the vulnerability data determining from the plurality of network security policies engine (106), a matching vulnerability policy module (128) that matches the respective vulnerability data (108) and a data from a connection traffic of security information management (“SIM”) products, enterprise risk management (“ERM”) or the like, that contains the risk score rating (126) and extract the risk score rating (126) from the matching vulnerability policy module (128). The system processing further determines and implement a best-matching risk remediation policy and procedure for the monitored network and then indicate a report of a vulnerability activity (130) in the vulnerability data (108) and associated remediations for the asset of the network.

In an embodiment, the vulnerability data (108) is identified through a vulnerability scanner in the threat management module (116) configured to perform a vulnerability scan for the networked assets.

In an embodiment, the threat management module (116) further integrated with a compliance management module (114) wherein the compliance management module (114) performing the associated policies remediations for the asset by tracking the incident progress based on ISMS implementation standard, Risk Management in Information Technology (RMIT), Information Technology Service Management (ITSM), or Business Continuity Management System (BCMS). The threat management module (116) further integrated with a compliance management module (114) wherein the compliance management module (114) performing the security standards ISO 27001 with versioning function to track major or minor changes to the security documents.

The present invention provides a computer-implemented method of constructing a convolutional neural network-based for a monitored network security platform, the method comprising monitoring a vulnerability data (108) of the monitored network including the data from an asset (118) of at least one end point device and a data from connection traffic of security information management (“SIM”) products, enterprise risk management (“ERM”) or the like, in accordance with the network security policies engine (106),) for performing the security standards ISO 27001 with versioning function to track major or minor modification of changes data to the security documents, determining a risk assessment metrics (124) of the vulnerability activity (130), whether the monitored network is complying with the network security policies engines (106), calculating the risk assessment metrics (124) of at least an asset (118) of the network based on the vulnerability activity (130) and whether the monitored network is complying with the network security engines (106), automizing a stage of the risk assessment metrics (124) via one or more machine learning methods to generate a risk score rating (126) of the network wherein the scores rating (126) are generating from the vulnerability activity (130) with predetermined parameters, and receiving an indication of the risk assessment metrics (124) of an initial change of at least an asset of the monitored network with customizing at least an internal and external vulnerability data.

In an embodiment, the method further matching a vulnerability policy module (128) that matches the respective vulnerability activity (130) in the vulnerability data (108) and a data from connection traffic of security information management (“SIM”) products, enterprise risk management (“ERM”) or the like and that contains the risk score rating (126) and extract the risk score rating (126) from the matching vulnerability policy module (128), training the first vulnerability data set from a user requirement of the distributed sources and a second vulnerability data set from the processor (102) in the monitored network to indicate the overall risk rating level of the monitored network, determining and implementing a best-matching risk remediation policy and procedure for the vulnerability activity (130) in the monitored network, and ranking and reporting the vulnerability activity (130) in the network and associated remediations for the asset of the monitored network based on tracking the incident progress of ISMS implementation standard.

In a preferred embodiment, a computer program product comprising an instruction for the execution of the steps of the network monitoring method when said program is executed by a computer.

In a preferred embodiment, a computer-readable recording medium on which a computer program is recorded comprising instructions for carrying out the steps of the network monitoring method.

Many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF DRAWINGS

For a better understanding of the nature and objects of the invention, reference should be made to the following detailed description taken in connection with the accompanying drawings forming a part of this specification and in which similar numerals of reference indicate corresponding parts in all the figures of the drawings.

FIG. 1A-1B illustrates a perspective view of the preferred embodiment of a computer implemented system and method related to cloud computing infrastructure of the present invention.

FIG. 2A-2B illustrates the unified cybersecurity management module and its implementation used in the preferred embodiment.

FIG. 3A-3B illustrates a flow chart of the system used in the preferred embodiment.

FIG. 4 illustrates an integration module of the system used in the preferred embodiment

FIG. 5 illustrates an example of screen shots of an integrated system used in the preferred embodiment

FIG. 6A-6D illustrates example screen shots of an integrated report generated by the system in the preferred embodiment.

### DETAILED DESCRIPTION OF PREFERRED EMBODIMENT

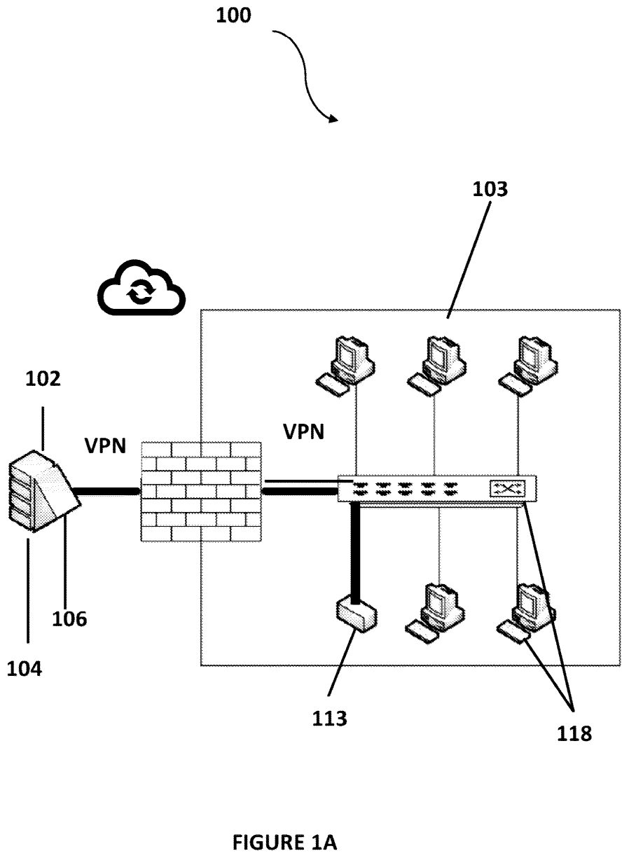

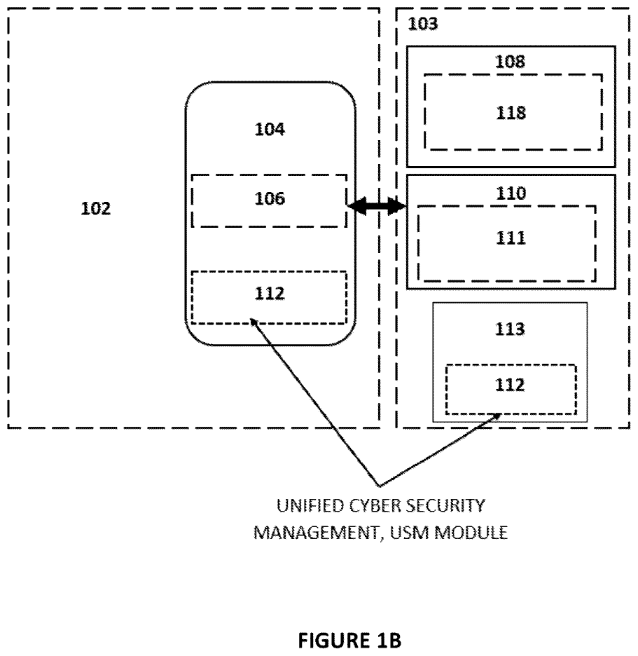

Referring to the drawings and initially to FIG. 1A to 1B. FIG. 1A illustrates an example platform in which cybersecurity analysis can be provided for various level of user in real time via multiple devices. In accordance with an embodiment of the present disclosure, it should be understood that all examples herein are provided for illustrative purposes and that many variations are possible. In one embodiment, an example unified cybersecurity analysis module 112 can be configured to acquire data from operational information technologies devices or assets in a monitored network or system. Based on the acquired data, the unified cybersecurity analysis module 112 can facilitate providing cybersecurity analysis based on operational information technologies in the monitored network.

As shown in the example of FIG. 1A, the monitored network can include client network environment in an organization's premises which associates with assets devices of overall state of a networked system including endpoint devices and connectivity traffic.

Information is an asset which, like other important business assets, has value to an organization and consequently needs to be suitably protected. Issues like network theft, facility failure, network failure and physical security threat, data leakage and cyber-attack will be routed through the gateway and firewall in the monitored network where malicious traffic is blocked, and legitimate traffic is accelerated. Furthermore, information technologies can connect to public networks, such as the internet. As such, in some instances, operational information technologies can be vulnerable to viruses, malware, hackers, errors, inadvertent/mistaken operation, and/or other cyber threats.

In one embodiment of FIG. 1A, the acquired vulnerability data is either carried out in-house or through a cloud-based security system. Information and other data related need a fast, secure, and reliable way to share information across computer networks. The present invention provides a computer implemented system to transmit the acquired data via a virtual private network (VPN). A VPN is a private network that uses a public network (usually the internet) to connect remote sites or users of the monitored network together. The VPN uses “virtual” connections routed through the internet from the user's private network to the remote site or agents to manage the user's site in the system. The acquired data is intercepting to the encrypted data through the VPN connectivity.

In one embodiment, the cybersecurity management module 112 may resides in the processor 102 or monitored network 103 thru an agent 113. It provides as a stand-alone appliance that connects to a network. The cybersecurity management module 112 can be provided in other ways, such as software running on a server, distributed software, or various software and hardware packages operating together. The cybersecurity management module 112 connects to a monitored network 103 such as a local area network (LAN), Intranet network and isolated virtual network thus, can collect data from various sources. For example, the cybersecurity management module 112 can collect acquired data from a plurality of agents 113. Agent 113 is an agent associated with and overseeing a network device or any handheld devices which associated with a processor. The cybersecurity management module 112 can also collect information data from, routers, firewalls, connected assets, vulnerability scanners, security information management (SIM) products, enterprise risk management (ERM) products and other such products and applications.

With reference to FIG. 1B, the computing platform 100 includes at least one processing unit 102 and a database 104 configured to store a network security policies engine 106. The processor executes a computer-executable instruction whereby it resides the software for implementing one or more of system and methods of the described embodiments. An interconnection mechanism such as controller, switches or network interconnects the components of the computing platform 100.

The acquired data will then be transferred to the processor whereby it displayed the unified cybersecurity management dashboard to provide end to end cybersecurity solution for various level of user accessed in real time via handheld devices.

### Unified Cybersecurity Management Module

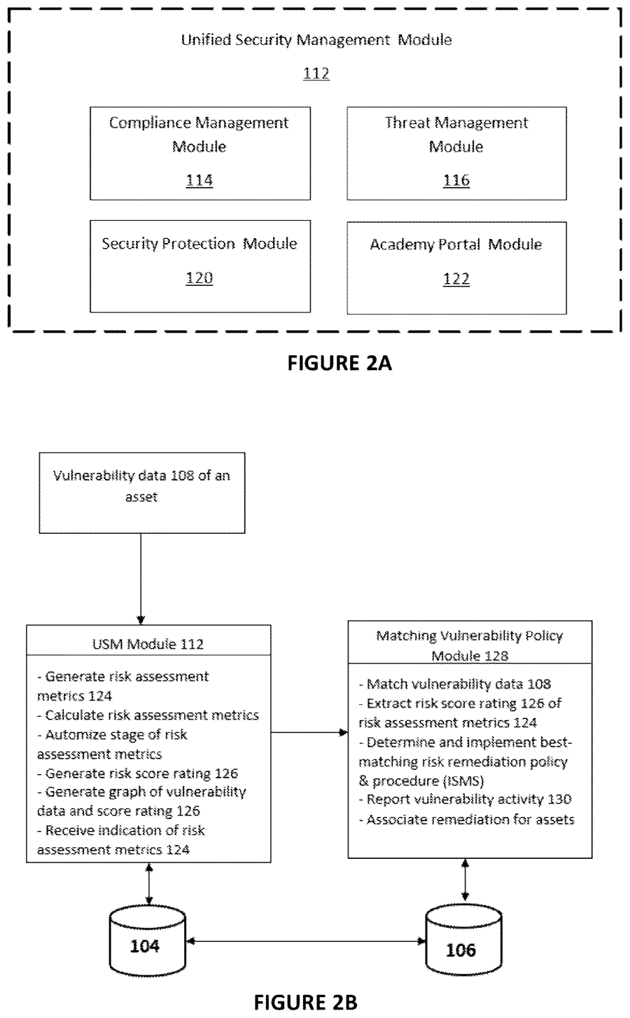

One embodiment of the invention is now described with reference to FIG. 2A to 2B. FIGS. 2A and 2B shows an implementing a unified cybersecurity management module 112. In one embodiment, the cybersecurity management module 112 includes a compliance, threat, and protection management module.

With references to FIG. 2B, in one embodiment, the USM module 112 dynamically generating a risk assessment metrics 124 of the vulnerability data 108, whether the monitored network is complying with the network security policies engines 106. The module further implements calculating the risk assessment metrics 124 of the asset 118 of the monitored network based on the vulnerability data 108 and whether the network is complying with the network security policies engines 106. The risk assessment metrics 124 is automized via one or more machine learning methods to generate a risk score rating 126 of the monitored network wherein the score rating 126 are generating from the vulnerability data 108. The risk-based management tool managing the information security which encompasses the business process, critical system elements and critical system boundaries. It involves a continuous improvement program to maintain the effectiveness of an organisation's information security management to meet changing risk and threat environment by implementing ISMS framework.

In one embodiment, the compliance management module 114 is for monitoring and analyzing the acquired vulnerability data 108 and identifying an optimum changing reference information of the data 108 that corresponds to a network security policies engine 106 with an Information Security Management System (ISMS) implementation standard. Under ISO27001 standard, it defined as the management preservation of information that prevents unauthorized disclosure of systems and information. It ensuring the information is accessible only to those who authorized to have an access. It also prevents unauthorized modification of the systems and information and safeguarding the accuracy and completeness of information and processing methods. Ensuring that authorized users have access to information and associated assets when required.

In an embodiment, a threat management module 116 is for scanning a plurality of an asset devices 118 of the monitored network that associate with the vulnerability data 108 including the data from an asset of at least one end point device and a data from a connection traffic. The threat management module 116 performs asset discovery by collecting information about all assets connected to and/or visible to the network 103. Such assets can include, but are not limited to, laptops, desktops, workstations, operating systems and other applications, servers, users, routers, intrusions detection devices (IDS), firewalls, printers, and storage systems. Assets can be imported from various connected applications, such as vulnerability scanners, directory applications, ERM, SIM, and other security-related products, and so on.

The security protection module 120 for dynamically accessing the at least information of the vulnerability data 108 for monitoring cyberattack and thereafter for updating an antivirus of the asset and web application is implemented in the system.

In an embodiment, the academy portal module 122 for interacting with information security policy knowledge such as a user awareness campaigns, and a set of phishing simulator email to be transmitted through a plurality of messaging channels in the monitored network to executes the phishing campaign and tracks the results of a vulnerable possibilities.

In an embodiment, the integrated unified cybersecurity management module 112 further generate a graph of the information security in accordance with the vulnerability data 108 and the score rating 126 via a graphical user interface which is a main dashboard of the system. The module will receive an indication of the risk assessment metrics 124 of an initial change of at least an asset of the monitored network.

The vulnerability data 108 may further integrated with the risk assessment metrics 124 for centrally processing the vulnerability data 108 to threat priority associated therewith, the processing comprising, for each vulnerability data 108, the vulnerability data determining from the plurality of network security policies engine 106 in the compliance management module 114 whereby it performs a threat detection by integrating the threat management module 116. The system may implement a matching vulnerability policy module 128 that matches the respective vulnerability data 108 that contains the risk score rating 126. The system may extract the risk score rating 126 from the matching vulnerability policy module 128 thus determine and implement a best-matching risk remediation policy and procedure 316 for the organization of the monitored network. In another embodiments, the best-matching remediation policy and procedure may extend to Risk Management in Information Technology (RMIT), or Information Technology Service Management (ITSM), or Business Continuity Management System (BCMS) basically known to those skilled in the art.

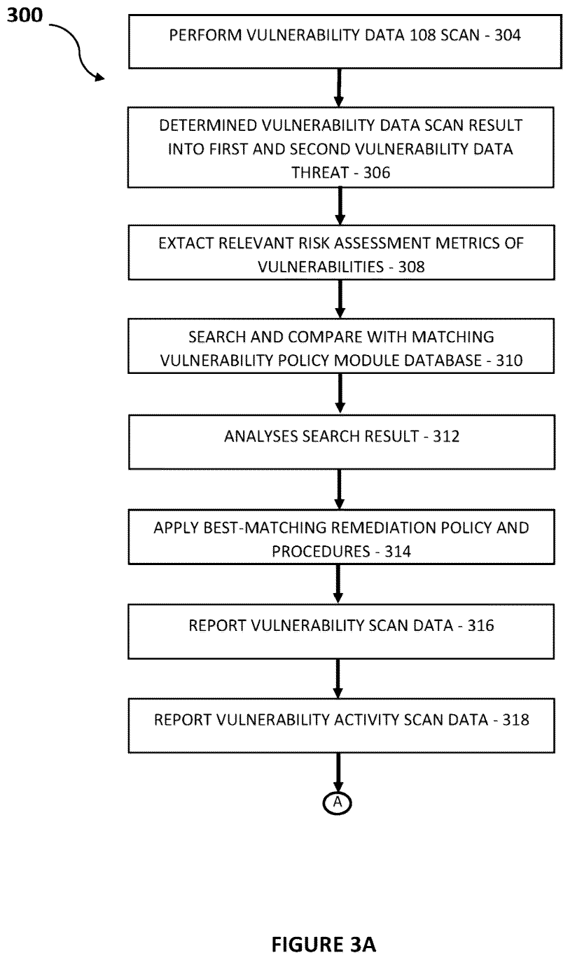

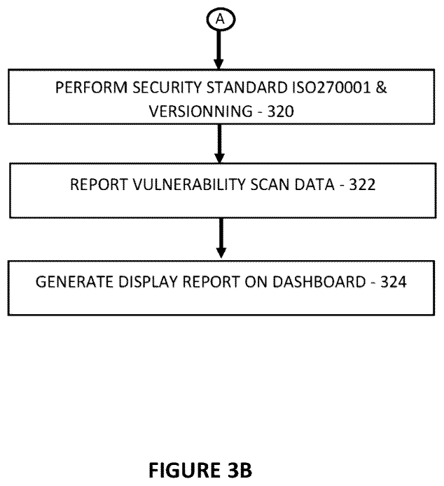

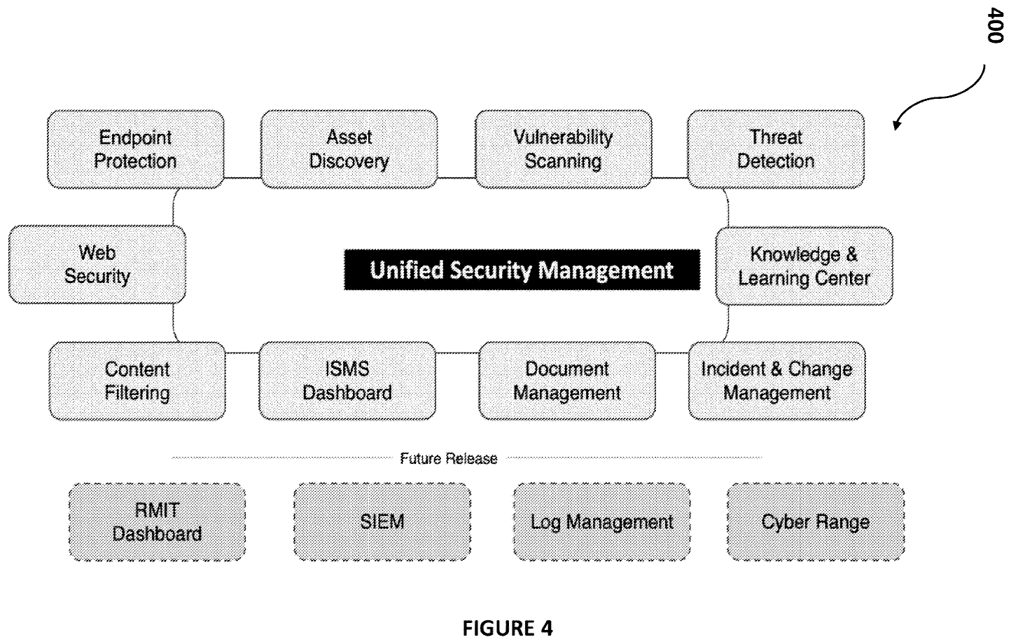

FIG. 3 is a logic flow that illustrates one embodiment of an exemplary system and method for transforming and securely routing the acquired data that may be configured to determine the vulnerability data 108 from a plurality of data sources of an assets. As shown, the data is scanning by a vulnerability scanner 304 means. A vulnerabilities scanner may be any data scanner known to those skilled in the art such as Nessus, Open Vas or Zap Scanner. In various embodiments, asset discovery function and asset verification may own by the organizations or a user or optionally via a scanner provided by the system. The vulnerability data 108 may comprising a first vulnerability data set 306 from a user requirement of a distributed sources and a second vulnerability data set 306 from the processor 102 in the monitored network.

As shown, the system may report a vulnerability activity 318 in the vulnerability data 108 and then associated a remediations for the asset of the network. The associated policies remediations for the assets is generally based on a tracking of the incident progress of ISMS implementation standard. The system may further perform a security standards ISO 270001 with versioning function 320 to track major or minor changes to the security documents. The main function of the system may elaborate a project tasks and further documentation of associated policies remediations where user can audit the data by create, edit, change, and approve the documents. An advantage for auditing purposes i.e., an auditor or user just needs to look at the cloud-based computer implemented system for auditing, with no more manual checking. Auto versioning may be implemented for a new SOP documentation based on major n minor revision i.e., major 2.0 or minor 1.2—In one embodiment, user may decide whether the versioning is a major or minor modification of data.

In one embodiment, with references to FIG. 2B, the invention is also may exploited vulnerabilities via Artificial Intelligence (AI) whereby the system may construct a convolutional neural network-based method for the monitored network security platform. The method comprising i. monitoring a vulnerability data 108 of the monitored network including the data from an asset 118 of at least one end point device and a data from connection traffic in accordance with the network security policies engine 106, ii. determining a risk assessment metrics 124 of the vulnerability activity 130, whether the monitored network is complying with the network security policies engines 106; iii. calculating the risk assessment metrics 124 of at least an asset 118 of the network based on the vulnerability activity 130 and whether the monitored network is complying with the network security engines 106; iv. automizing a stage of the risk assessment metrics 124 via one or more machine learning methods to generate a risk score rating 126 of the network wherein the scores rating 126 are generating from the vulnerability activity 130; v. generating a formulated graph of a security information in accordance with the vulnerability data 108 and the scores rating 126 of at least an asset 118 of the network via a graphical user interface; and vi. receiving an indication of the risk assessment metrics 124 of an initial change of at least an asset of the organization.

In one embodiment, the system can generate and propose best practice SOP for information security for a particular company based on industry sector, size, environment, and client budget. The AI will be able to learn from the existing data and SOP in the dynamic database not only data from compliance management module, but also from the threat and security protection module. The integration with all modules would then make the invention is a complete system for determining the best security management platform for a user or an organization like hospital, government agencies, schools, companies and even an individual organization. It was also could easily customizing with other external sources of document management to come out with the best practice SOP for the company or organization. This invention can be used for a new user in developing their own cybersecurity SOPs and an existing user or client that would like to upgrade and improve their SOPs to be at par or better than their competitor.

In one embodiment, the invention also able to propose the best technical solution based on an incident and change management on information security. This is done by learning the existing proprietary internal vulnerability data and external vulnerability data and the solution implemented for a particular vulnerability. This function enables better optimisation of cybersecurity resources and delivering a more streamlined incident management.

Another embodiment, the invention was able to rate (benchmark) a particular company based on its current security practice/SOP on information security, notwithstanding whether it is a new or existing client. The rating will provide the company with some self-assessment on their current security practice and further allow them to compare themselves with other companies. This rating will also help the company to understand what measures and improvements they need to do to achieve a better rating. The rating is being done by having the AI to learn and compare the SOP from other companies and further rate them according to the predetermined parameters.

In one embodiment, the system may submits reporting the vulnerability activity 130 in the network and associated remediations for the asset of the monitored network and user may review and all incident and change modifications will the dynamically display in a main dashboard of the system.

In one embodiment, upon establishing a secure real-time connection, the system and method may obtain dynamic updates through a secure connection (SSL) of a cloud-network-based asset data, vulnerability remediation data, asset management data, CVE test data, policy and procedures, and regulatory compliance data.

The system may also automatically update an information of a network security policies engine plugins to ensure the system continues to stay current with methodologies to protect against hackers. To this end, it establishes a secure connection through SSL to obtain all available latest engine plugins that are not already installed on the monitored network. The users may obtain these updating engine plugins through the ‘administrative dashboard’ through electronic cloud-based functionality.

The system may allow for executing links, instructions, modules, executable patches, and security fixes from the user application for repair and remediation of vulnerabilities and related regulatory compliance weaknesses of each vulnerability that has been identified for the monitored network-based asset, on a per IP address basis.

A secure graphical user interface or dashboard executing on the processor that provides an interface for the user to configure the product for their organization and network environment. It provides an administrative dashboard employing data received from the system and managed the assets of their network. Further, it can create configurations to audit the assets in their network, access, and display reports on the vulnerabilities of their networks for the subscription service including up sells to the products, downloads of compliance documents. This will also provide an interface to a dashboard where the user can track the changes in the network, see logging information of the activity on the end-point assets and more generally any compiled security information which can be obtained from the knowledge gathered about the assets in the network. Each screen is dynamically generated as a result of web-based input from the end users. Other methods include the development of a GUI using the HTML programming language supported by MYSQL databases with Perl, Python or PHP tied into a small web application server.

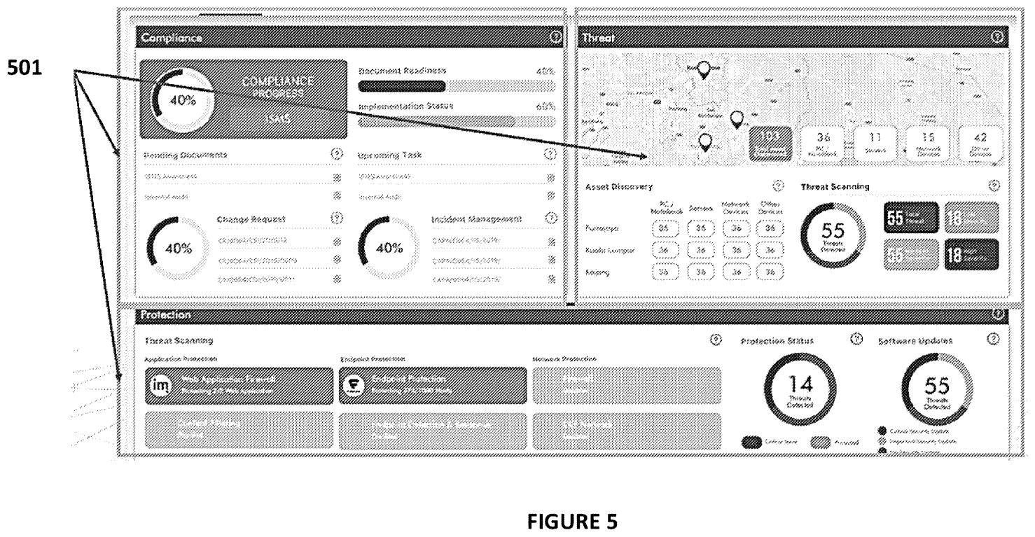

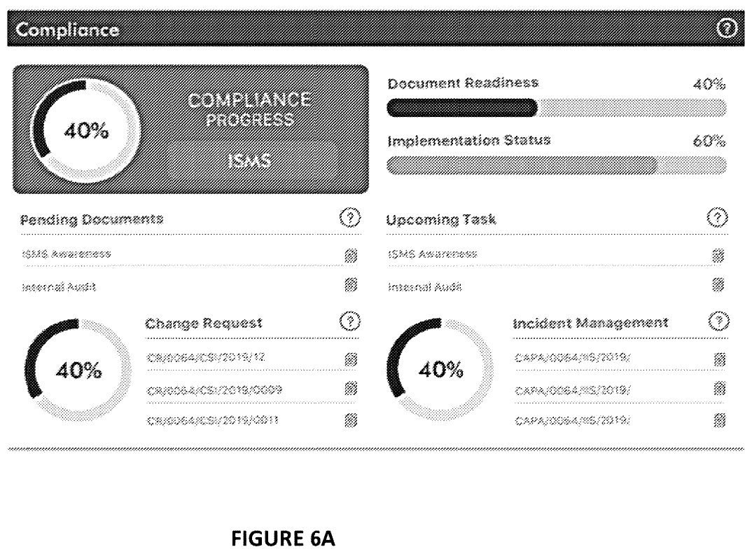

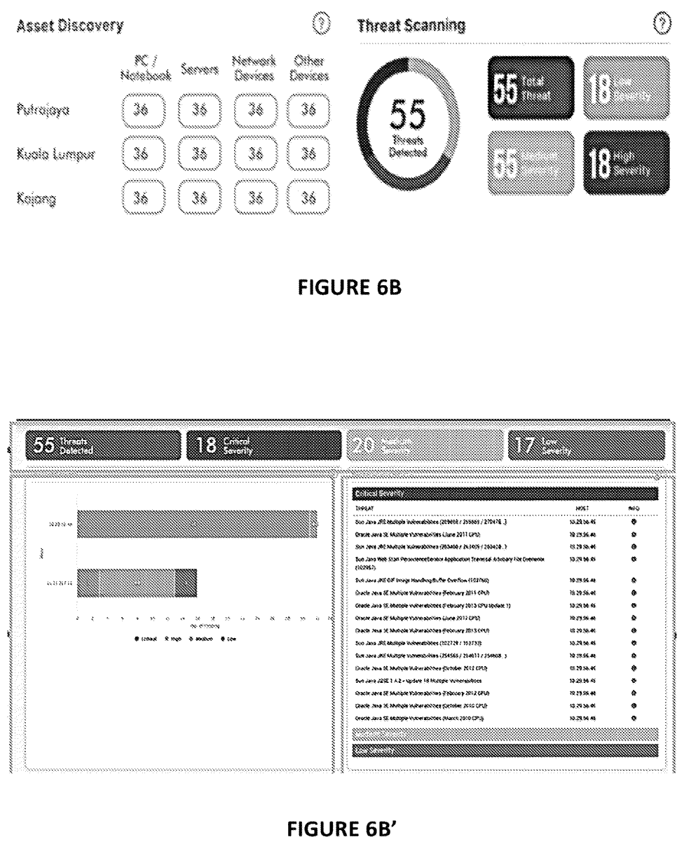

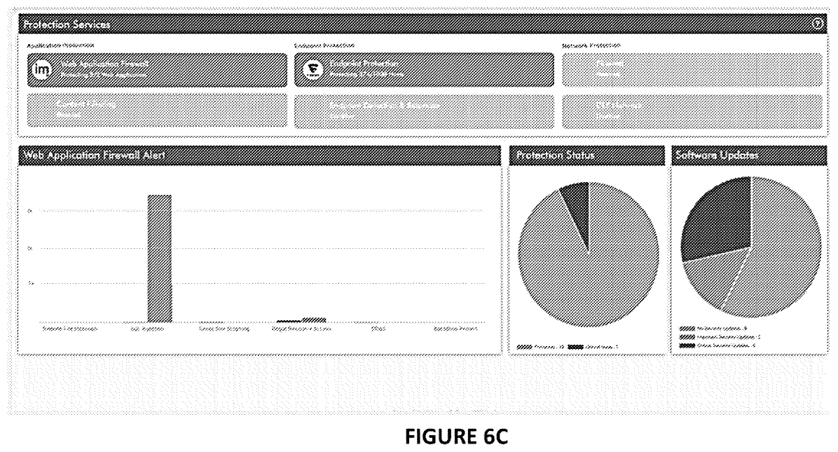

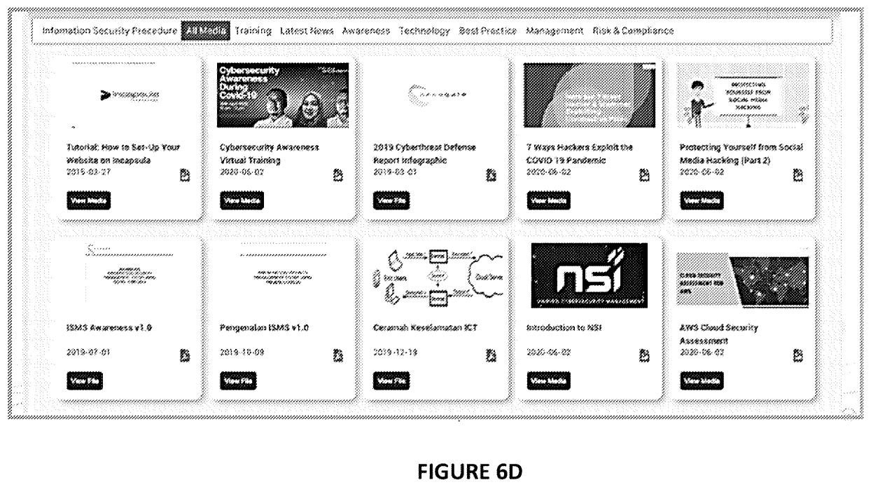

In one embodiment, for example, FIG. 5 illustrate an exemplary on an executive dashboard with all-in-one integrated unified security management, USM module of the system. FIG. 6A to 6C, illustrates an exemplary GUI or dashboard generated by user interface or dashboard. Referring to FIG. 6A, is an executive dashboard intended to be viewed by a registered user. GUI 400 may include such as a selection area of “Pending Documents”, Change Request” and “Incident Management” where user can select which document needs to update with security documentation and view on compliance progress 401 in terms of documents readiness or implementation status of the acquired data of the documents.

As view in FIGS. 6B and 6B′, it shows how many assets has been discovered by the system. It includes cater information of the assets from various locations and view the results of threats detected by its category whether its low severity, medium severity, or high severity.

While in FIG. 6C, it illustrates the graph of the status results of an “Application Protection”, “Endpoint Protection” and “Network Protection”. The system integrated in generating an alert of a network severity status whether its fully protected and/or any updates on software has been implemented towards the monitored network. FIG. 6D is an exemplary of the academy portal module for interacting with information security policy knowledge for a user.

For a security access control, a secure communications sub-system engine which provides a secure method in which an end-user can access the system and all the functionality of that system as well as providing secure means in which to upload and download files, reports, subscription data and in general any relevant data compiled, generated, or related to the functionality of the system. The secure communications subsystem engine uses the secure internet protocol of secure sockets layer (SSL) or the secure hypertext transfer protocol to share information between the GUI user client and the Micro appliance security and vulnerability management server.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since nunlerous modifications and changes will readily occur to those skilled in the art, it is not desired to limit the invention to the exact construction and operation shown and described, and accordingly, all suitable modifications and equivalents may be resorted to, falling within the scope of the invention. The invention described herein is susceptible to variations, modifications and/or additions other than those specifically described, and it is to be understood that the invention includes all such variations, modifications and/or additions which fall within the scope of the following claims.

What is claimed is:

1. A computer implemented system cybersecurity management platform (100) for a monitored network comprising:
one or more processors (102) coupled to a dynamically-generated electronic database (104), the database configured to store an information of a network security policies engine (106) associated with a vulnerability data (108);
one or more displays (110) coupled to the processor configured to display an interface of the network security policies engine (106) that provides an executive dashboard (111) for user access; and
an integrated unified cyber security management, USM module (112) within the monitored network wherein the USM module (112) includes:
a compliance management module (114) for monitoring and analyzing the vulnerability data (108) and identifying an optimum changing reference information of the data (108) that corresponds to a network security policies engine (106) with an ISMS implementation standard;
a threat management module (116) for scanning a plurality of an asset (118) of the monitored network that associate with the vulnerability data (108) including the data from an asset of at least one end point device and a data from a connection traffic;
a security protection module (120) for dynamically accessing the at least information of the vulnerability data (108) for monitoring cyberattack and thereafter updating an antivirus of the asset and web application; and
an academy portal module (122) for interacting with information security policy knowledge including a phishing simulator to be transmitted through a plurality of messaging channels in the monitored network;
wherein, the USM module (112) dynamically generating a risk assessment metrics (124) of the vulnerability data (108), whether the monitored network is complying with the network security policies engines (106); calculate the risk assessment metrics (124) of at least an asset (118) of the network based on the vulnerability data (108) and whether the network is complying with the network security policies engines (106); automize a stage of the risk assessment metrics (124) via one or more machine learning methods to generate a risk score rating (126) of the monitored network wherein the score rating (126) are generating from the vulnerability data (108); generate a graph of the information security in accordance with the vulnerability data (108) and the score rating (126) via a graphical user interface; and receive an indication of the risk assessment metrics (124) of an initial change of at least an asset of the monitored network.

2. The system (100) as claimed in claim 1, wherein the vulnerability data (108) further comprising a first vulnerability data set from a user requirement of distributed sources and a second vulnerability data set from the processor (102) in the monitored network.

3. The system (100) as claimed in claims 1 and 2, wherein the vulnerability data (108) further integrated with the risk assessment metrics (124) for centrally processing the vulnerability data (108) in order to threat priority associated therewith, the processing comprising, for each vulnerability data (108), the vulnerability data determining from the plurality of network security policies engine (106):
a matching vulnerability policy module (128) that matches the respective vulnerability data (108) that contains the risk score rating (126) and extract the risk score rating (126) from the matching vulnerability policy module (128); determine and implement a best-matching risk remediation policy and procedure for the monitored network; and report a vulnerability activity (130) in the vulnerability data (108) and associate remediations for the asset of the network.

4. The system (100) as claimed in claims 1 to 3, wherein the vulnerability data (108) is identified through a vulnerability scanner in the threat management module (116) configured to perform a vulnerability scan for the networked assets.

5. The system (100) as claimed in claim 4, wherein the threat management module (116) further integrated with a compliance management module (114) wherein the compliance management module (114) performing the associated policies remediations for the asset based on tracking the incident progress of ISMS implementation standard.

6. The system (100) as claimed in claim 5, wherein the threat management module (116) further integrated with a compliance management module (114) wherein the compliance management module (114) performing the security standards ISO 27001 with versioning function to track major or minor changes to the security documents.

7. A computer-implemented method of constructing a convolutional neural network-based for a monitored network security platform, the method comprising:
i. monitoring a vulnerability data (108) of the monitored network including the data from an asset (118) of at least one end point device and a data from connection traffic in accordance with the network security policies engine (106);
ii. determining a risk assessment metrics (124) of the vulnerability activity (130), whether the monitored network is complying with the network security policies engines (106);
iii. calculating the risk assessment metrics (124) of at least an asset (118) of the network based on the vulnerability activity (130) and whether the monitored network is complying with the network security engines (106);
iv. automizing a stage of the risk assessment metrics (124) via one or more machine learning methods to generate a risk score rating (126) of the network wherein the scores rating (126) are generating from the vulnerability activity (130);
v. generating a graph of the security information in accordance with the vulnerability data (108) and the scores rating (126) of at least an asset (118) of the network via a graphical user interface; and
vi. receiving an indication of the risk assessment metrics (124) of an initial change of at least an asset of the organization.

8. The computer-implemented method as claimed in claim 7, further comprising:
i. matching a vulnerability policy module (128) that matches the respective vulnerability activity (130) in the vulnerability data (108) and that contains the risk score rating (126) and extract the risk score rating (126) from the matching vulnerability policy module (128)
ii. training the first vulnerability data set from a user requirement of the distributed sources and a second vulnerability data set from the processor (102) in the monitored network to indicate the overall risk rating level of the monitored network;
iii. determining and implementing a best-matching risk remediation policy and procedure for the vulnerability activity (130) in the monitored network; and
iv. ranking and reporting the vulnerability activity (130) in the network and associated remediations for the asset of the monitored network.

9. A computer program product comprising instructions for the execution of the steps of the network monitoring method according to any one of claims 1 to 8 when said program is executed by a computer.

10. A computer-readable recording medium on which a computer program is recorded comprising instructions for carrying out the steps of the monitoring method according to any one of claims 1 to 9.
